(19) United States
(12) Patent Application Publication
(10) Pub. No.: US 2010/0055015 A1
(43) Pub. Date: Mar. 4, 2010

(54) Low temperature mercury control process

(76) Inventors: Richard A. Winschel, Pittsburgh, PA (US); Michael L. Fenger, Pittsburgh, PA (US); Robert M. Statnick, Cornelius, NC (US)

Correspondence Address: BUCHANAN INGERSOLL & ROONEY PC, P.O. BOX 1404, ALEXANDRIA, VA, 22313-1404, US

(21) Appl. No.: 11/825,299

(22) Filed: Jul. 5, 2007

Related U.S. Application Data
(60) Provisional application No. 60/830,659, filed on Jul. 13, 2006.

(51) Int. Cl. B01D 53/50; B01D 53/64; B01D 53/34

(52) U.S. Cl. 423/243.08; 423/242.1; 423/210; 422/168

(57) ABSTRACT

The Low Temperature Mercury Control, or LTMC, process is a technology developed by us for controlling mercury emissions from coal-fired power plants. In the LTMC process, mercury emissions are controlled by cooling the exhaust flue gases with an air heater (or water spray) beyond the typical 300° F. to about 200-220° F., thereby promoting mercury absorption on the coal fly ash. The fly ash containing the absorbed mercury is then captured in the power plant's existing particulate collection device. An alkaline material, magnesium hydroxide slurry in our tests, is injected to eliminate sulfur trioxide (sulfuric acid) which could otherwise condense at the cool temperature and corrode or foul the power plant's air heater and ductwork.

### CROSS-REFERENCE TO RELATED APPLICATIONS

This application claims the benefit of priority of U.S. Provisional Patent Application No. 60/830,659, filed on Jul. 13, 2006. That application is incorporated by reference as if fully rewritten herein.

### STATEMENT REGARDING FEDERALLY SPONSORED RESEARCH OR DEVELOPMENT

This invention was made with government support under DE-FC26-01NT41181 awarded by the DOE. The Government has certain rights in this invention.

### BACKGROUND OF THE INVENTION

The following includes information that may be useful in understanding the present teachings. It is not an admission that any of the information provided herein is prior art, or material, to the presently described or claimed subject matter, or that any publication or document that is specifically or implicitly referenced is prior art. All publications in this document are incorporated by reference herein.

Co-benefit mercury removal using existing electrostatic precipitators has been reported by a number of authors. See, e.g., C. L. Senior & S. A. Johnson, “Impact of Carbon-in-Ash on Mercury Removal across Particulate Control Devices in Coal-Fired Power Plants” (Air Quality IV Conference, September 22-24, Arlington, Va.); Winschel, et al., “Control of Mercury Emissions by Absorption on Flyash” (DOE/NETL Mercury Control Technology R&D Program Review Meeting, Pittsburgh, Jul. 14, 2005); and Rosenhoover, W. A., “Correlate Fly Ash Capture of Hg with Ash Carbon Content and Flue Gas Temperature” (Final Technical Report, ICCI Project No.: 98-1/1.2B-2). They reported a relationship between flue gas temperature and high carbon content fly ash.

In 2001, EPA issued the Mercury Information Collection Request (MICR). EPA required about 60 utility boilers to monitor mercury emissions from coal-fired power plants. The utilities reported a highly variable mercury removal due to some unknown process across the particulate control device.

After release of the MICR utility data, mercury control using the inherent carbon in the ash has been a topic of research. For example, U.S. Pat. No. 6,027,551, to Hwang, et al., reports a process to enhance the carbon content of fly ash by separating the carbon from fly ash and re-injecting the recovered carbon into the flue gas duct to increase the fly ash carbon content. The carbon may be from fly ash, wood ash, or other charred carbonaceous materials. According to Hwang, the carbon is separated from the fly ash by a variety of techniques, including electrostatic separation, floatation, and gravity separation.

Sjostrom, et al., “Mercury Removal Trends in Full-Scale ESPs and Fabric Filters” (Presented at A&WMA Specialty Conference on Mercury Emissions: Fate, Effects, and Control and The US EPA/DOE/EPRI Combined Power Plant Air Pollutant Control Symposium: The Mega Symposium, Chicago, Ill., Aug. 20-23, 2001) presented data that suggest a highly variable mercury removal across ESPs and fabric filters. They concluded that there was “. . . no significant correlations with LOI, coal chlorine, or temperature . . . ” Rosenhoover and Senior & Johnson reported a correlation between LOI and mercury removal. In addition, Rosenhoover reported a correlation between mercury removal and flue gas temperature. Lastly, GE Environmental Services (DOE/NETL Mercury Control Technology R&D Program Review, Jul. 13, 2005 and DOE/NETL Conference on Reburning for NOx Control, Morgantown, W.V., May 18, 2004) reported a process to increase the fly ash LOI concentration by varying combustion conditions. Based on pilot-scale tests, GE reported that the mercury reduction increased as the fly ash LOI increased and as the temperature was lowered from 350 to 270 F. at the air heater outlet.

### BRIEF SUMMARY OF THE INVENTION

We have developed a mercury control process that is applicable to stoker-fired, pulverized coal- and cyclone-fired boilers. Captured mercury may be elemental, oxidized, or particulate mercury forms. The process also includes methods to control SO₃, methods to lower flue gas temperature, and methods to enhance the reactivity of the unburned carbon in the fly ash. Embodiments of the invention include the integration of several different concepts including the correlation of carbon mass flow rate and percent mercury reduction.

The Low Temperature Mercury Control, or LTMC, process is a technology for controlling mercury emissions from coal-fired power plants. In the LTMC process, mercury emissions are controlled by cooling the exhaust flue gases. Cooling may be done, for example, with an air heater or water spray. Exhaust flue gases are cooled below the typical 300° F. to about 200-220° F. This promotes mercury absorption on the coal fly ash. The fly ash containing the absorbed mercury is then captured in the power plant's existing particulate collection device. An alkaline material is injected to eliminate sulfur trioxide (sulfuric acid) which could otherwise condense at the cool temperature and corrode and foul the power plant's air heater and ductwork. In one embodiment the alkaline material is magnesium hydroxide, though in other embodiments the alkaline material is a metal salt selected from one or more of alkaline earth oxide, alkaline earth hydroxide, alkaline earth carbonate, alkali oxide, alkali hydroxide, alkali carbonate, and/or alkali bicarbonate. The alkali metal salt may be a finely divided powder, a slurry, or, because it is water soluble, in solution. While the percent solids in the slurry is not critical, in one embodiment 10 to 15 wt % solids in the alkali earth salt slurry is employed.

In addition to controlling mercury emissions, the technology reduces the emissions of sulfur trioxide and alleviates the visible plume problem sometimes associated with selective catalytic reduction applications and the corrosion and build-up of ash on air heater surfaces and duct walls, and improves the mercury capture capacity of the inherent carbon in the fly ash. The technology can also allow improved generating efficiency if the cooling is effected by an air heater (rather than by water sprays); this would lead to reduced fuel usage and lower emissions of carbon dioxide and other pollutants.

We conducted pilot scale and full-scale experiments to define the relationship between fly ash carbon content and the flue gas temperature. We identified that mercury removal increased as the flue gas temperature decreased and the fly ash carbon content (% Loss On Ignition, or “LOI”) increased. In FIG. 1, this relationship is shown. For the lowest flue gas temperature (200-210° F.), there is a clear relationship between increasing carbon content and percent mercury removal. As the flue gas temperature increases, the relationship between mercury removal and increasing fly ash carbon content becomes weaker.

Embodiments of the invention provide a method for optimizing mercury removal from flue gas resulting from coal burned in a boiler. This method may comprise measuring total particulate loading of the flue gas to obtain the number of grains per unit volume of the flue gas and the volumetric flow (in volume per minute) of the flue gas. This measurement may be taken, for example, using United States Environmental Protection Agency Method 5, “Determination of Particulate Matter Emissions from Stationary Sources,” which is incorporated by reference herein. Following measurement of particulate loading, fly ash is obtained from the flue gas, and at least one of loss on ignition (LOI) or percent carbon of said fly ash is determined. This is used to determine the amount of carbon in the flue gas (in weight per unit volume). Mercury removal is then optimized by increasing the amount of carbon in the flue gas to an amount greater than about 44 pounds of carbon per million cubic feet of flue gas.

In alternative embodiments of the invention, the amount of carbon in the flue gas is increased, for example, by reducing oxygen content of the flue gas as measured at an economizer section of the boiler, or by increasing particle size of carbon leaving a pulverizer supplying coal to the boiler. These methods may also be used in combination. The percentage of oxygen gas may, for example, be reduced from a nominal 3% to between 2% and 3%. The calculations above may then be repeated until a desired level of mercury reduction is reached.

### BRIEF DESCRIPTION OF THE FIGURES

FIG. 1 depicts mercury removal as a function of flue gas temperature and fly ash carbon content.

FIG. 2 depicts the relationship between mercury removal and carbon treat rate.

FIG. 3 depicts a pilot plant flow chart for an embodiment of the invention.

FIG. 4 depicts injection of an alkaline material into a flue gas after the economizer and before the air heater.

FIG. 5 depicts injection of an alkaline material into a flue gas after the air heater and before the particulate removal device.

FIG. 6 depicts addition of alkaline material prior to the air heater combined with flue gas cooling to enhance mercury removal.

FIG. 7 depicts flue gas cooling combined with alkaline injection into the flue gas after it passes through the air heater.

FIG. 8 depicts a performing alkaline injection before or after the air heater, as well as flue gas cooling, and reducing the boiler oxygen concentration.

FIG. 9 depicts alkaline material injection prior to movement of the flue gas through the air heater, as well as cooling of the flue gas.

FIG. 10 depicts alkaline material injection after the flue gas has moved through the air heater, as well as cooling of the flue gas.

FIG. 11 depicts adjusting the boiler excess air to increase flue gas carbon mass flow, with alkaline material injection either before or after the air heater, and with flue gas cooling.

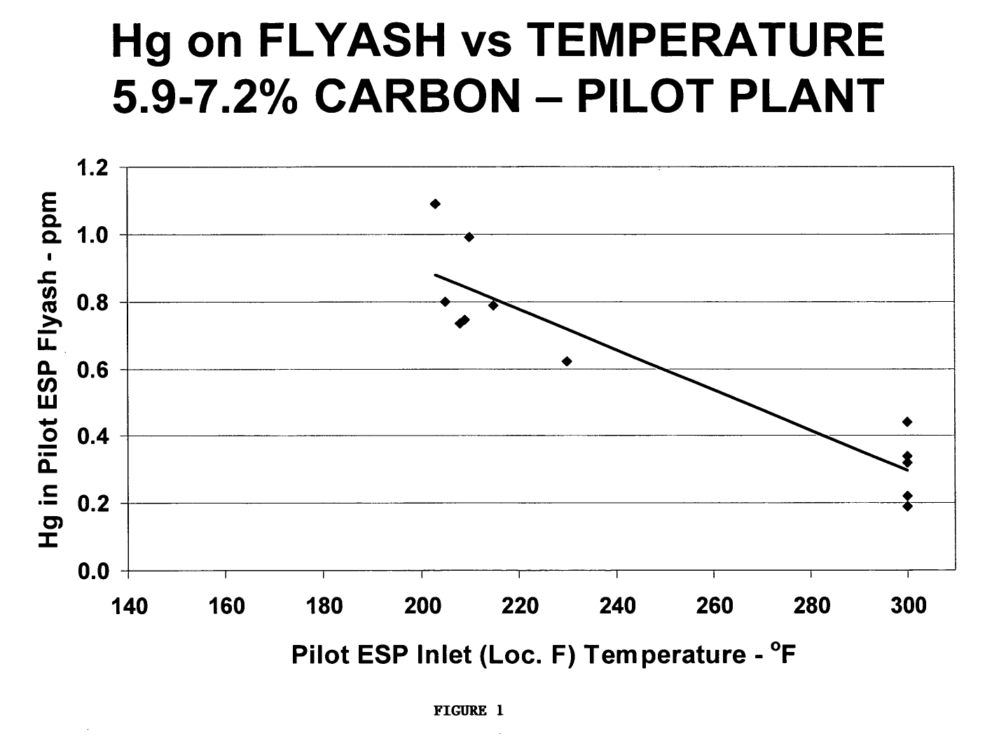

### DETAILED DESCRIPTION OF THE INVENTION

There are several different coal boiler firing modes. For example, utilities use cyclone-, pulverized coal-, and stoker-fired boilers. Each of these firing modes produces a different concentration of fly ash in the flue gas. Coal contains different weight percent ash; the coal ash concentration ranges between about 8 to over 15% by weight. The firing mode and the coal ash content variation reduce the predictive capability of the relationship between percent carbon in the fly ash (or % LOI) and mercury reduction. For example, 80% of the ash in the as-fired coal is emitted as fly ash in a pulverized coal fired boiler and only 20% of the ash in the as-fired coal is emitted as fly ash in a cyclone-fired boiler. In a pulverized coal-fired boiler, firing an as-fired coal which has an uncontrolled particulate mass flow rate of 3 gr/acf (grams/actual cubic feet), 12% carbon in the fly ash, and the flue gas flow rate of 1 million acfm, the carbon mass flow rate is 51.4 lb/MMacf. The calculation method is presented in Equation 1.

pounds of carbon/million cubic feet=A*B*C/7000 grains/lb Equation 1

where

A=fly ash concentration expressed as grains per actual cubic foot

B=1,000,000 actual cubic feet per minute

C=either percent Loss on Ignition or percent carbon in the fly ash

For an as-fired coal which has an uncontrolled particulate mass flow rate of 0.5 gr/acf, 12% carbon in the fly ash, and a flue gas flow rate of 1 million acfm, the carbon mass flow rate is 8.57 lb/MMacf. (“MMacf” is “million actual cubic feet.”). Of course, those skilled in the are will recognize that the units may be freely converted between the English and metric systems without affecting the invention.

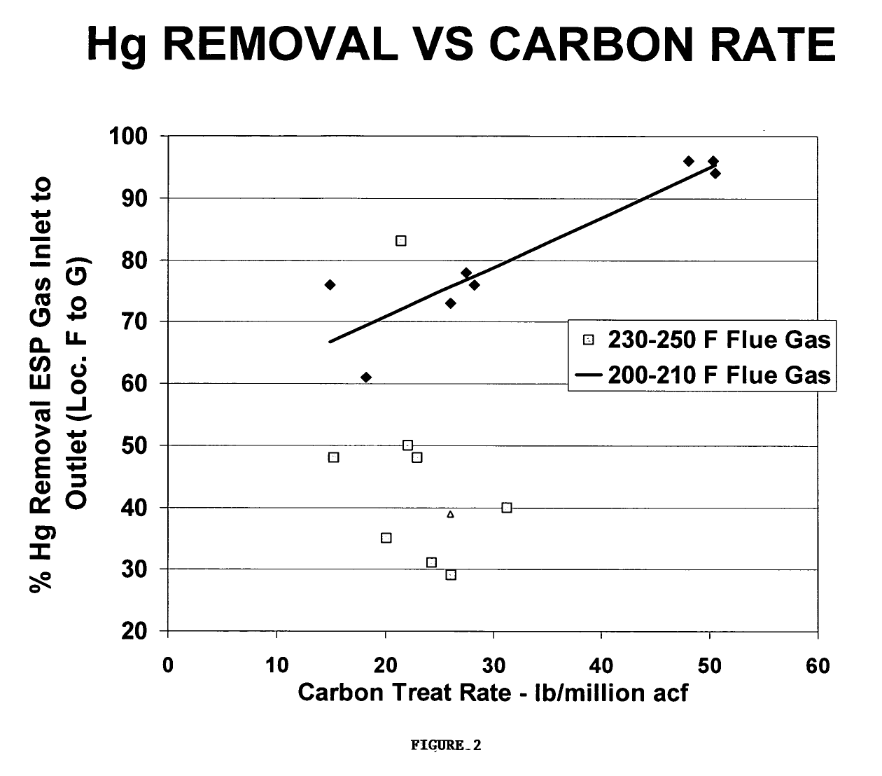

We investigated the relationship between carbon mass flow rate and mercury removal. In FIG. 2, the relationship between mercury removal and carbon treat rate is presented. This presentation removes the issues related to coal ash content and firing mode from the relationship between mercury removal and percent carbon in the ash or percent LOI.

At constant temperature, decreasing the carbon mass flow rate decreases the mercury removal. At constant carbon mass flow rate, increasing the flue gas temperature lowers the mercury reduction. For greatest mercury removal, the flue gas temperature should be between 200 to 210° F. and the fly ash carbon mass flow rate should be over 45 lb/million acf. This results in 90+% mercury reduction.

We recognized that mercury removal best occurs at flue gas temperatures that may be lower than the sulfuric acid dew point. We combined the low temperature mercury control process with a sulfur-trioxide (SO₃) control process. In embodiments of the invention these two processes work in conjunction with each other. We employed magnesium hydroxide slurry injection prior to the air heater to control SO₃ emissions. At Mg(OH)₂ slurry injection: SO₃ mole ratios of 4/1 to 5/1, over 90% of the SO₃ was removed. This protects the down stream ductwork, particulate control equipment, fans, and other equipment from sulfuric acid corrosion.

The SO₃ removal step permits the process to be used in conjunction with Selective Catalytic Reduction processes to control NOx emissions. See, for example, United States Published Patent Application No. 20060177366, which is incorporated by reference herein. This step includes injecting an alkali metal or alkaline earth oxide, carbonate, or hydroxide into the flue gas to remove S0₃ and reduce down stream corrosion and air heater fouling. Embodiments of the invention also include reducing the flue gas temperature to 200 to 250° F. to enhance the mercury removal at constant LOI or fly ash carbon treat rate. Other embodiments of the invention include reduction of the flue gas temperature to 200 to 240° F., 200 to 230° F., 200 to 220° F., 200 to 215° F., 200 to 210° F., and to about 200° F.

To better understand the mercury reduction percentage, we have developed a carbon treat rate formula. This removes the boiler firing mode as a variable. For example, 10% LOI or carbon in the fly ash means different values of carbon per million actual cubic feet. For a cyclone boiler, only 20% of the coal ash reports as fly ash. Whereas, for a pulverized coal fired boiler, 80% of the coal ash reports as fly ash. At a given LOI concentration, there is four times as much carbon in the pulverized coal-fired boiler fly ash as is present in the cyclone-fired fly ash. This means that the carbon treat rate is very different for these two cases. We express this relationship as shown in Equation 2:

PC/CYC=A*B*0.8/C*D*0.2 Equation 2

where:

PC=pulverized coal-fired combustion

CYC=cyclone-fired coal combustion

A=pounds of coal fired per hour in a PC boiler

B=Percent ash in the coal

C=pounds of coal fired per hour in a CYC boiler

D=Percent ash in the coal.

For electric generators of the same capacity (coal feed rate), identical electric generating heat rate, and firing the same coal, the equation 2 reduces to the ratio PC/CYC=4.0

In further embodiments of the invention fly ash LOI or carbon treat rate may be varied by altering the flue gas oxygen concentration. Reducing the flue gas oxygen concentration increases the fly ash LOI or carbon treat rate. For example, oxygen content may be lowered from about 3 to 3.5% by volume to about 2 to 3% by volume. Reducing the oxygen concentration to 2 to 3 % can increase the fly ash LOI from 4 weight percent to 10 weight percent. The actual increase is dependent on a number of variables such as coal mill settings, coal hardness, and boiler mixing. This modification does not need to be related to reducing NOx emissions; it can be used to increase the fly ash LOI or carbon treat rate. As an alternative, the fly ash carbon content can be increased by modifying the coal mill operation.

### EXAMPLES

### Pilot Plant Construction

We constructed and operated a pilot plant using the flue gas from a coal-fired power generating station equipped with the LTMC technology. The performance of the process toward mercury removal and sulfur trioxide control, the influence of operating conditions, and the certain balance-of-plant impacts were evaluated at a 3640 scfm slip-stream pilot plant.

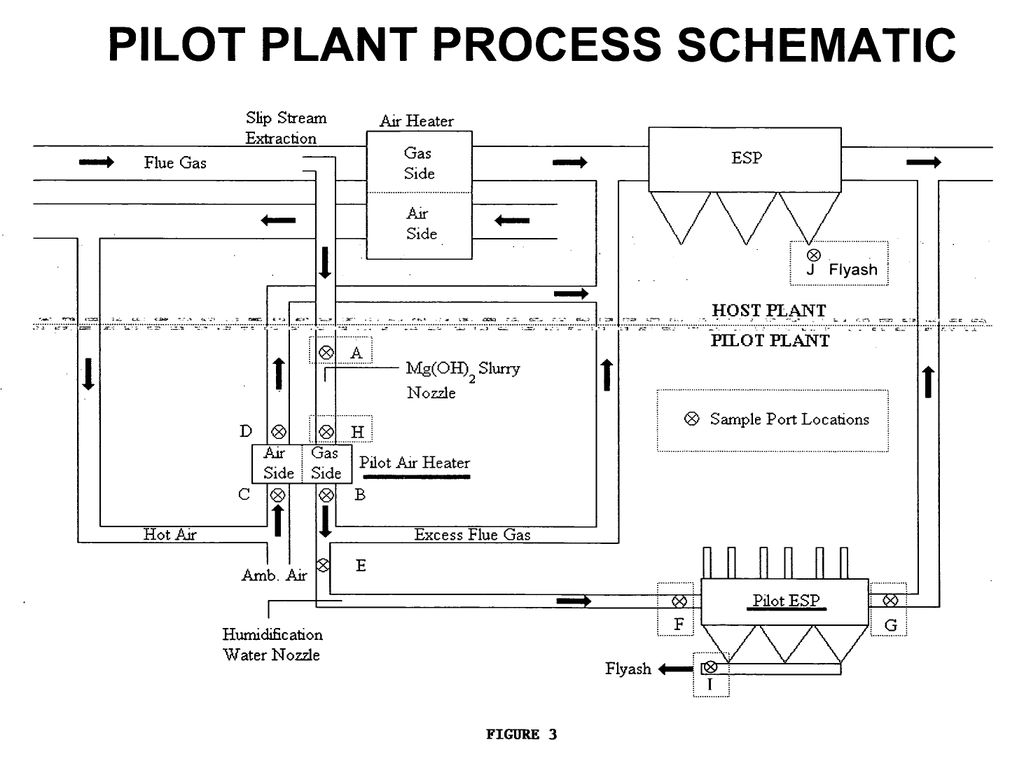

The pilot plant extracted flue gas immediately downstream of the plant's economizer and routed the extracted gas through a magnesium hydroxide slurry injection system, a pilot air heater, a water spray system, and a pilot electrostatic precipitator (ESP), as shown in FIG. 3. During tests, samples of the flue gas were taken at various locations in the pilot plant, and samples of fly ash were taken to determine the performance of the process. During the testing, the pilot plant burned high-sulfur northern Appalachian bituminous coal. Ancillary testing included evaluations of the performance of the air heater and electrostatic precipitator (ESP), an air heater corrosion evaluation, and an evaluation of the stability of the mercury captured on the fly ash. The pilot plant testing was conducting over the course of 15 months.

At baseline conditions (i.e.; at normal station operating conditions of 300° F. ESP inlet), mercury removal was about 25%. Mercury removal was sensitive to the flue gas temperature and the concentration of unburned carbon in the fly ash. The pilot plant fly ash typically contained 6-15% unburned carbon. At experimental conditions of 200-210° F. at the ESP inlet, mercury removals of up to 96% were demonstrated. 90% mercury removal can be achieved by cooling the flue gas to 200° F. at the ESP inlet, provided that the fly ash contains 8% unburned carbon (assumes the coal contains 10% ash).

Injection of dilute magnesium hydroxide slurry, at a Mg/SO₃ molar ratio of 4/1, downstream of the economizer effectively removed sulfur trioxide to less than 3 ppmv at the air heater inlet and eliminated fouling of the air heater elements; this was true even during deep-cooling (<230° F.) periods of up to 75 hours with no sootblowing. The performance of the pilot ESP was not adversely affected by LTMC operating conditions (i.e.; at very low SO₃ concentrations less than 3 ppmv and low temperature about 220 to 200° F.).

The pilot plan program demonstrated that very high mercury removals, exceeding 90%, could be achieved by a fairly simple process. It appears likely that the process is most applicable to bituminous coals, because of the sensitivity of the mercury removal to unburned carbon content. No balance-of-plant problems were identified in the pilot program. These results justify larger-scale testing and demonstration.

### Example 1a

### Injection of Alkaline Material at 700 to 600° F.

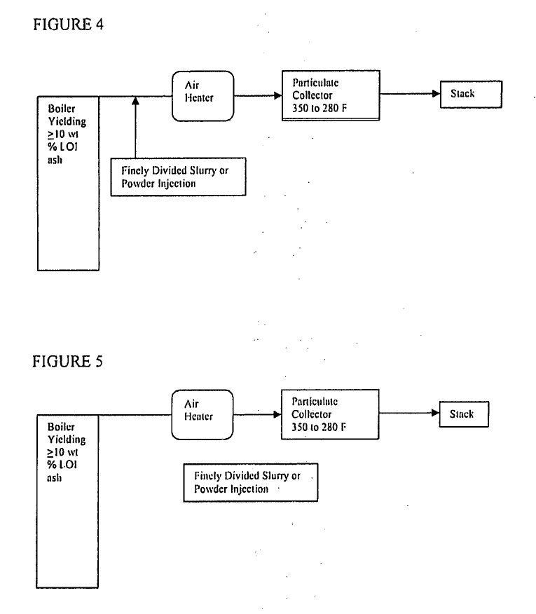

The diagram for Example 1a is shown in FIG. 4.

In Example 1a, a finely divided powder or slurry (solution) of Ca (OH)₂, NaHCO₃, or other alkaline earth metal oxide, hydroxide, or carbonate or alkali metal oxide, hydroxide, or carbonate is injected into the flue gas duct work after the economizer and before the air heater. The alkali earth or alkali metal compounds are to absorb SO₃ produced during combustion or by the Selective Catalytic Reduction system installed to reduce NOx emissions. Removing the SO₃ will enhance the mercury capture capability of the inherent carbon in the fly ash.

### Example 1b

### Injection of Alkali Material at 350 to 280 F.

The diagram for Example 1b is shown in FIG. 5.

In Example 1b, the finely divided powder or slurry (solution) is injected after the air heater and prior to the particulate control device. The finely divided powder or slurry (solution) is composed of alkaline earth metal oxides, hydroxides, or carbonates or of alkali metal oxides, hydroxides, or carbonates. The purpose is to remove SO₃ produced during the combustion of coal or by the Selective Catalytic Reduction system installed to remove NOx. Removing the SO₃, enhances the mercury removal capability of the inherent carbon in the fly ash.

### Example 2a

Method of Alkaline Material Injection Prior to Air Heater Combined with Flue Gas Cooling

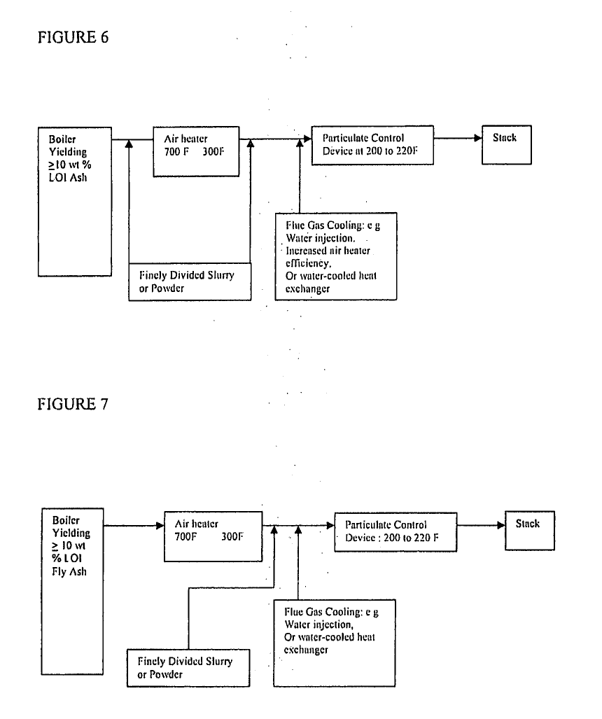

The diagram for Example 2a is shown in FIG. 6.

In Example 2a, the SO₃ removal step is combined with flue gas cooling to enhance mercury removal. In this example, the alkaline earth or alkali metal carbonates, hydroxides, or oxides are injected as a fine dry powder or as a slurry (solution) into the flue gas duct after the boiler economizer and before the air heater to remove the SO₃ . This improves the air heater reliability (eliminates down time for air heater washing) and enhances the mercury capture capability of the inherent carbon in the fly ash. The mercury capture capability of the inherent carbon in the fly ash can also be improved by reducing the flue gas temperature. The flue gas is cooled after the powder or slurry (solution) injection step. Cooling is accomplished by increasing the air heater duty cycle. Reducing the air heater exit temperature by 50° F., increases the boiler efficiency by about 1%. This reduces carbon emissions while generating the same level of electricity. In the example cited, the flue gas temperature is reduced by 100° F., and the boiler efficiency is increased by about 2%. The flue gas can also be cooled by direct water injection or an additional heat exchanger (such as a water cooled heat exchanger). Data indicate that the final temperature is the key parameter not how that temperature is achieved. The water injection or water heater exchanger will not improve the boiler efficiency. By lowering the flue gas temperature and removing the SO₃, this process will improve the mercury capture capability of the inherent carbon in the fly ash.

### Example 2b

Method of Alkali Material Injection after the Air Heater Combined with Flue Gas Cooling

The diagram for Example 2b is shown in FIG. 7.

In Example 2b, the alkaline earth or alkali metal injection and the flue gas cooling are after the air heater. The alkali earth or alkali metal carbonates, hydroxides, or oxides are injected after the air heater to remove excess SO₃ and enhance the mercury capture capability of the inherent carbon in the fly ash. To further increase the mercury capture capability of the inherent carbon, the flue gas temperature is lowered from a nominal 300° F. to 220 to 200° F. Lower flue gas temperatures increases the mercury capacity of the inherent carbon. This scheme allows fly ashes containing more than 10% LOI (or carbon in the ash) to remove up to 90% of the inlet mercury concentration.

### Example 2c

Method of either Alkali Injection Prior to or Post the Air Heater, Flue Gas Cooling, and Reducing the Boiler Oxygen Concentration

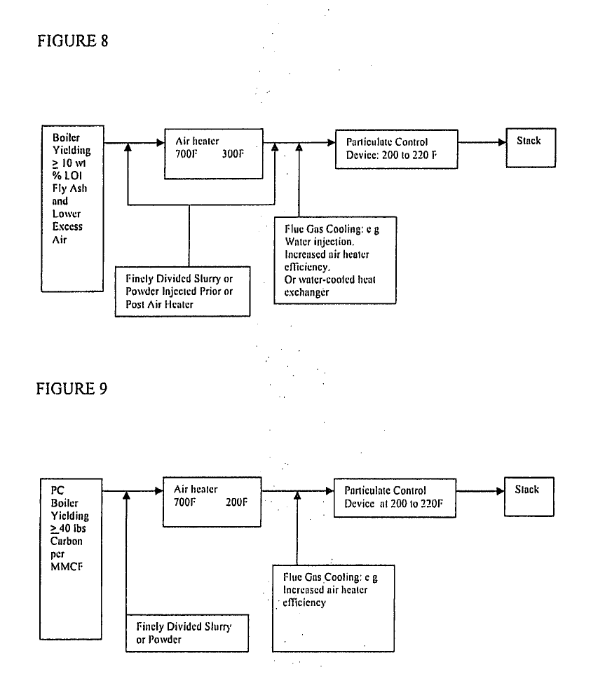

The diagram for Example 2c is shown in FIG. 8.

In Example 2c, the pulverized coal-fired boiler is producing a fly ash that contains less than 10% LOI. In this example, the oxygen content of the flue gas, as measured at the economizer exit or equivalent location, is lowered from the nominal 3 to 3.5% to 2.0 to 2.8%. This has two impacts. First, the boiler efficiency is increased by lowering the mass flow rate of flue gas and secondly, the fly ash LOI concentration is increased to 10% LOI or more. The alkaline earth or alkali metal carbonate, oxide, or hydroxide is injected into the flue gas either prior to the air heater or after the air heater. Prior to the air heater is preferable. In this step, the SO₃ is removed which enhances the mercury removal capacity of the inherent carbon in the fly ash. Next, the flue gas is cooled from a nominal 300° F. to 200 to 22° F. using water injection, a more efficient air heater, or a water cooled heat exchanger. Reducing the flue gas temperature increases the removal capacity of the inherent carbon in the fly ash. Combining these three approaches will improve boiler efficiency, adjust the fly ash LOI to an appropriate level, and will increase the mercury removal capacity of the inherent carbon in the fly ash.

### Example 3a

Method of Alkali Material Injection Prior to Air Heater Combined with Flue Gas Cooling

The diagram for Example 3a is shown in FIG. 9.

In Example 3a, CONSOL has developed a correlation equation which relates the percent mercury reduction to the mass flow rate of the carbon in the fly ash, expressed as pounds/million cubic feet. This equation removes the boiler-firing mode as a variable. For example, in a pulverized coal-fired boiler, 80% of the coal ash reports as fly ash. In a cyclone-fired boiler, 20% of the coal ash reports as fly ash. CONSOL has determined that at a carbon mass flow rate of about 40 lbs/MMcf, the mercury removal is 90%. This translates into 10% LOI for a pulverized coal-fired boiler and over 40% LOI for a cyclone boiler. The equation makes all boiler types equivalent.

In this example, the flue gas cooling is achieved by increasing the air heater efficiency. The flue gas enters the air heater at a nominal 700° F. and exits at 200 to 220° F. To prevent SO₃ condensation and corrosion, alkaline earth or alkali metal carbonates, hydroxides, or oxides are injected into the flue gas either as a fine powder or as fine slurry. Removing the SO₃ will enhance the mercury capture capability of the inherent carbon in the fly ash and increases the boiler efficiency. The particulate matter, fly ash, is controlled by either an ESP or a bag house.

### Example 3b

Method of Alkali Material Injection Post the Air Heater Combined with Flue Gas Cooling

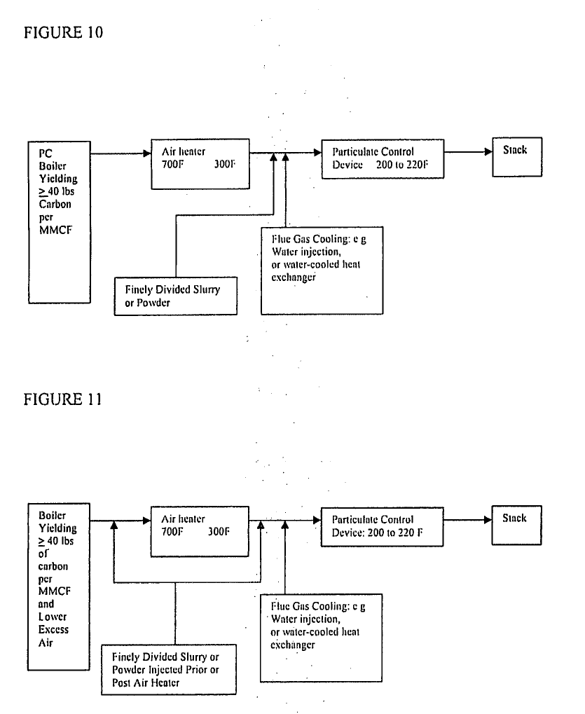

The diagram for Example 3b is shown in FIG. 10.

In Example 3b, the boiler is operated such that 40 lbs/MMcf of carbon are produced. The statements of the first paragraph of the previous example apply in the instance.

In this example, the finely divided powder or fine slurry are injected after the air heater. No benefit of improved boiler efficiency is achieved. However, the flue gas SO₃ is removed and the mercury capture capacity of the inherent carbon in the fly ash is increased. In addition, the flue gas temperature is lower by either spraying a fine mist of water droplets or by using a water heat exchanger. The flue gas temperature is reduced from 300° F. to 200 to 220° F. Lowering the flue gas temperature increases the mercury capture capacity of the inherent carbon in the fly ash. Using this approach, if the carbon mass flow rate was greater than 40 lbs/MMcf and the flue gas temperature was reduced to 200 to 220° F., the mercury removal would be about 90%.

### Example 3c

Method of Adjusting the Boiler Excess Air to Increase Flue gas Carbon Mass Flow, Alkali Material Injection either Prior to or Post the Air Heater and Flue Gas Cooling

The diagram for Example 3c is shown in FIG. 11.

In example 3c, the initial carbon content of the flue gas is less than 40 lb/MMcf. To increase the flue gas carbon content, the boiler economizer oxygen content is reduced from 3.0 to 3.5% oxygen to 2.0 to 2.8% oxygen. This change has two effects. First, the reduction in flue gas oxygen content increases the net boiler efficiency and second, the lower flue gas oxygen content increases the carbon mass flow rate. The increased carbon mass flow rate will increase the mercury removal.

To further improve the mercury capture capability, the flue gas temperature can be reduced and the flue gas SO₃ content can also be reduced. A finely divided powder or fine mist of slurry are injected into the flue gas prior to the air heater or post the air heater. The fine powder or slurry is composed of either an alkaline earth or alkali metal carbonate, hydroxide, or oxide. These compounds react with flue gas SO₃ to form the corresponding sulfates. When the SO₃ condensation risk has been removed, the flue gas temperature is reduced from a nominal 300° F. to 200 to 220° F. by either injecting a fine mist of water droplets or the use of a water cooled heat exchanger. The SO₃ removal and reducing the flue gas temperature enhance mercury capture of the inherent carbon in the fly ash. If the flue gas contained 40 lbs/MMacf of inherent carbon and the flue gas temperature was between 220 and 200° F., the mercury removal would be about 90%.

We claim:

1. A method for removing mercury and sulfur trioxide from flue gas resulting from combustion of a fuel comprising carbon, sulfur, and mercury, comprising:
(a) mixing with the flue gas at least one metal salt selected from the group consisting of an alkaline earth oxide, alkaline earth hydroxide, alkaline earth carbonate, alkali oxide, alkali hydroxide, alkali carbonate, and alkali bicarbonate;
(b) adhering mercury to fly ash in said flue gas;
(c) reducing flue gas temperature to less than 210° F.; and
(d) removing the adhered mercury and carbon from said flue gas.

2. The method of claim 1, wherein the temperature of flue gas in step (a) is in a range selected from the group consisting of between 600 to 700° F. and between 280 to 350° F.

3. The method of claim 1, wherein the molar ratio of metal salt to sulfur trioxide is between 4.5 to 1 and 5.5 to 1.

4. The method of claim 3, wherein the molar ratio of metal salt to sulfur trioxide is about 5 to 1.

5. The method of claim 1, wherein said combustion occurs in a pulverized coal-fired boiler, and wherein the amount of carbon in the fly ash is at least 8% Loss on Ignition (LOI).

6. The method of claim 1, wherein said combustion occurs in a cyclone coal-fired boiler, and wherein the amount of carbon in the fly ash is at least 44% LOI.

7. The method of claim 1, including the step of lowering oxygen content of the flue gas to about 2% to about 3% by volume.

8. The method of claim 1, wherein said flue gas temperature is lowered in step (c) by a member of the group consisting of water misting, water-cooled heat exchanger, or air-flue gas heat exchanger.

9. The method of claim 1, wherein the flue gas contains at least 40 pounds of carbon per million square feet of flue gas, and wherein at least 80% of the mercury in the flue gas, by weight, is removed.

10. The method of claim 9, wherein at least 90% of the mercury in the flue gas, by weight, is removed.

11. A system for removal of mercury and sulfur trioxide from flue gas, comprising:
(a) a combustion boiler feeding flue gas to an air-flue gas heat exchanger, said air-flue gas heat exchanger feeding cooled flue gas to a particulate control device, said particulate control device removing particulate from said cooled flue gas and feeding said cooled flue gas to a smokestack; and
(b) an alkaline material injector, said alkaline material injector situated to inject an alkaline material into the flue gas at least one location selected from the group consisting of between the combustion boiler and the air-flue gas heat exchanger, and between the air-flue gas heat exchanger and the particulate control device; and
(c) a flue gas conditioning system, said flue gas conditioning system situated to cool the flue gas immediately after the flue gas passes through the air heater.

12. The system of claim 11, wherein said flue gas conditioning cools the flue gas to a temperature less than 210° F.

13. The system of claim 11, wherein said flue gas conditioning is selected from the group consisting of a water mister, a water-cooled heat exchanger, or an air-flue gas heat exchanger.

14. The system of claim 11, wherein said particulate control device is selected from the group consisting of a fabric fiber baghouse and an electrostatic precipitator.

15. A method for optimizing mercury removal from flue gas resulting from coal burned in a boiler, the method comprising:
(a) measuring total particulate loading of the flue gas to obtain the number of grains per unit volume of the flue gas and the volumetric flow (in volume per unit time) of the flue gas;
(b) obtaining a fly ash sample from said flue gas, and measuring at least one of loss on ignition (LOI) or percent carbon of said fly ash;
(c) determining the amount of carbon in the flue gas (in weight per volume of flue gas);
(d) optimizing mercury removal from the flue gas by increasing the amount of carbon in the flue gas to an amount greater than forty-four (44) pounds of carbon per million cubic feet of flue gas.

16. The method of claim 15, wherein the amount of carbon in the flue gas is increased by at least one method selected from the group consisting of reducing oxygen gas concentration at the economizer of the boiler and increasing particle size of carbon leaving a pulverizer attached to the boiler.

17. The method of claim 16, wherein the percentage of oxygen gas is reduced below 3%.

18. The method of claim 16, wherein the percentage of oxygen gas is reduced to between 2% to 3% by volume.

19. The method of claim 18, further comprising the step of removing sulfur trioxide from said flue gas.

20. The method of claim 19, wherein said sulfur trioxide is removed from said flue gas by alkaline slurry injection.
